(19) United States
(12) Patent Application Publication
(10) Pub. No.: US 2004/0082675 A1
(43) Pub. Date: Apr. 29, 2004

(54) Rigid foams and a process for the production of such foams

(76) Inventors: Steven L. Schilling, Pittsburgh, PA (US); Edward E. Ball, Weirton, WV (US)

Correspondence Address: BAYER POLYMERS LLC, 100 BAYER ROAD, PITTSBURGH, PA, 15205, US

(21) Appl. No.: 10/281,733

(22) Filed: Oct. 28, 2002

(51) Int. Cl. C08G 18/00

(52) U.S. Cl. 521/155

(57) ABSTRACT

Rigid foams having good insulation properties are made by reacting a polyisocyanate with an isocyanate-reactive material in the presence of a blowing agent mixture composed of from about 1 to 70% by weight of a low boiling hydrogen containing chlorofluorocarbon, such as chlorodifluoromethane (HCFC-22) and from 30 to 99% by weight of a C₂-C₅ polyfluoroalkane, such as 1,1,1,3,3-pentafluoropropane (HFC-245fa).

### FIELD OF THE INVENTION

The present invention relates to a process for producing rigid foams with good insulation characteristics (as measured by k-factor) and to the foams produced by this process. The present invention also relates to blowing agents useful in producing foams with good insulation characteristics.

### BACKGROUND OF THE INVENTION

Rigid polyurethane foams and processes for their production are known. Such foams are typically produced by reacting an isocyanate with an isocyanate-reactive compound such as a polyol in the presence of a blowing agent. Chlorofluorocarbons were the blowing agents most commonly used until about 1996. However, when it became known that chlorofluorocarbons posed environmental problems, specifically the depletion of ozone in the earth's atmosphere, the search for alternative blowing agents began.

Among the blowing agents considered to be promising alternatives to the chlorofluorocarbons (CFCs) were the hydrogen-containing chlorofluorocarbons (HCFCs), hydrogen-containing fluorocarbons (HFCs), hydrocarbons, and mixtures of HCFCs and HFCs. HCFC-141b was one of the most promising replacements for CFCs as a blowing agent for rigid foams, however it is currently in the process of being eliminated as an environmentally acceptable blowing agent. One of the most promising replacements for HCFC-141b in many applications is HFC 245fa, which produces foams with properties very similar to those of foams produced with HCFC-141b in terms of both density and average k-factor at appliance operating temperatures. However, HFC 245fa is high in both cost and molecular weight, and more HFC 245fa is required to produce foams with properties similar to foam produced with HCFC-141b.

U.S. Pat. Nos. 5,889,006 and 5,840,212, disclose rigid foams made with a blowing agent mixture composed of from about 1 to about 30% by weight of at least one C₂-C₅ polyfluoroalkane and from about 70 to about 99% by weight of a liquid HCFC. These references disclose that levels of C₂-C₅ polyfluoroalkane above 30% by weight of the total blowing agent mixture have a detrimental effect upon thermal conductivity properties of the resultant foam.

U.S. Pat. No. 5,565,497 discloses a process for the production of filled rigid polymer foams in which a fluorochemical surfactant and a blowing agent that is a hydrogen containing halocarbon or a mixture of hydrogen containing halocarbons are used.

U.S. Pat. No. 5,397,808 discloses low thermal conductivity foams made with a combination of HCFC-141b, perfluorinated compounds and carbon black. The perfluorinated compounds taught to be useful in this blowing agent combination include perfluorinated aliphatic hydrocarbons, perfluorinated cycloaliphatic hydrocarbons, perfluorinated N-aliphatic amino ethers, cyclic amino ethers, 1,3- or 1,4-amino ethers, perfluorinated ethers and perfluorinated tertiary alkylamines.

U.S. Pat. No. 5,318,996 discloses rigid insulating polyurethane foams prepared from ternary blowing agent mixtures which blowing agent mixtures were composed of water, HCFC-22 or HCFC-141b and a perfluorinated hydrocarbon having from 3 to 8 carbon atoms.

U.S. Pat. Nos. 4,927,863 and 4,945,119 disclose a process for the production of closed-cell polyurethane foams in which a mixture of a 2 carbon hydrogen-containing halocarbon (such as HCFC-141b and HCFC-123) with a shrinkage-minimizing halocarbon such as any of the known CFCs, HCFC-22, HFC-32, HCFC-124, HCFC-133a, HFC-134a, HCFC-142b and HFC-152a is used as the blowing agent.

U.S. Pat. No. 4,960,804 discloses rigid foams produced using a blend of a chlorofluorocarbon and an alkyl alkanoate as the blowing agent. HCFC's such as 1,1-dichloro-2,2,2-trifluoroethane (HCFC 123) and 1,1-dichloro-1-fluoroethane (HCFC 141b) are among the chlorofluorocarbons taught to be suitable.

U.S. No. 4,996,242 discloses polyurethane foams made with two different halocarbons and an inert organic liquid are combined in specified amounts to form a ternary mixture which mixture is used as the blowing agent. The halocarbons taught to be suitable blowing agents for the disclosed ternary mixtures include at least one halocarbon having a boiling point below about 10° C. and at least one halocarbon having a boiling point from about 20 to about 35° C. Halocarbons having boiling points below 10° C. include 1,1-difluoroethane, 1-chloro-1,1-difluoroethane, 1-chloro-1,1,2,2,-tetrafluoroethane, 1-chloro-1,1,1,2-tetrafluoroethane and mixtures thereof. Halocarbons having a boiling point from 20 to 35° C. include trichlorofluoromethane, 1,1-dichloro-2,2,2-trifluoroethane and 1,1-dichloro-1-fluoroethane. The inert organic liquids which are included in these ternary mixtures include pentane and substituted pentanes, hexane and substituted hexanes and haloalkanes.

U.S. Pat. No. 5,057,547 discloses mixtures of specific hydrochlorofluorocarbons and specific hydrocarbons, which are useful in the production of rigid, closed cell foams. The HCFC's useful in these disclosed mixtures include 2,2-dichloro-1,1,1-trifluoroethane and 1,1-dichloro-1-fluoroethane. The hydrocarbons useful in these mixtures include n-pentane, 2-methyl butane, hexane, the position isomers of hexane and mixtures thereof.

U.S. Pat. No. 5,162,384 discloses foamed plastics made with blowing agent emulsions composed of at least one low boiling perfluorinated, N-aliphatic, cyclic 1,3- or 1,4-aminoether blowing agent, a foamable reaction mixture and a fluorochemical surfactant.

U.S. Pat. Nos. 5,254,601 and 5,272,183 each discloses HCFC-blown rigid foams having low thermal conductivities. These foams are produced using a blowing agent mixture that includes from about 0.1 to about 1.0% by weight water and 1,1-dichloro-2,2,2-trifluoroethane or dichlorofluoroethane.

U.S. Pat. No. 5,314,926 discloses foams blown with mixtures of 1,1,1,2,3,3,3-heptafluoropropane and one or more hydrocarbons or partially halogenated alkanes.

U.S. Pat. No. 5,470,891 discloses rigid polyisocyanate-based foams which are produced using water and a C₁₋₄ hydrofluorocarbon having a boiling point of 300° K or less as the blowing agent.

### SUMMARY OF THE INVENTION

It is an object of the present invention to provide a process for the production of rigid foams having good insulation properties.

It is also an object of the present invention to provide a blowing agent mixture for use in the production of rigid polyurethane foams which does not include a CFC.

It is another object of the present invention to provide rigid foams having low thermal conductivities, which are produced in the absence of HCFC-141b.

These and other objects which will be apparent to those skilled in the art are accomplished by reacting an organic isocyanate with an isocyanate-reactive compound in the presence of a blowing agent mixture made up of from 1 to 70% by weight of a gaseous hydrogen containing chlorofluorocarbon and from 30 to 99% by weight of a C₂-C₅ hydrogen-containing fluorocarbon.

### DETAILED DESCRIPTION OF THE PRESENT INVENTION

The present invention relates to a blowing agent mixture, to rigid foams having low thermal conductivities as measured by k-factor (i.e., a thermal conductivity which are similar to or lower than the thermal conductivity of a rigid foam produced using a single hydrochlorofluorocarbon, a single hydrofluorocarbon or a mixture of hydrofluorocarbons as a blowing agent) and to a process for the production of those foams in which no CFC or HCFC-141b are used as the blowing agent. Preferably, the present invention relates to rigid foams having thermal conductivities in the range of 0.130 to 0.136 BTU-in./hr.ft²° F. at 75° F.

The blowing agent mixture of the present invention is made up of from 1 to 70% by weight of a low boiling (b.p. <0° C.), hydrogen containing chlorofluorocarbon and from 30 to 99% by weight of a C₂-C₅ polyfluoroalkane.

Suitable gaseous HCFC's include chlorodifluoromethane (HCFC-22), 1-chloro-1,1-difluoroethane (HCFC-142b) and mixtures thereof. Preferably the HCFC is chlorodifluoromethane (HCFC-22).

Suitable C₂-C₅ polyfluoroalkanes include 1,1,1,3,3-pentafluoropropane (HFC-245fa), 1,1,1,2,3,3-hexafluoropropane (HFC-236ea), 1,1,1,3,3,3-hexafluropropane (HFC-236fa),1,1,1,3,3-pentafluorobutane (HFC-365mfc), and 1,1,1,4,4,4-hexafluorobutane (HFC-356mffm). Preferably, the C₂-C₅ polyfluoroalkane is 1,1,1,3,3-pentafluoropropane (HFC-245fa).

Preferably, the blowing agent contains from about 20 to 50% by weight of a hydrogen containing chlorofluorocarbon and from 50 to 80% by weight of a C₂-C₅ polyfluoroalkane.

Water may optionally be included in the blowing agent mixture of the present invention. If used, water is generally included in an amount of up to 2.0 weight percent, based on the total weight of the polyol blend.

As is known in the art, rigid foams are prepared by reacting polyisocyanates with isocyanate-reactive compounds. Any of the known organic polyisocyanates may be used in the present invention. Suitable polyisocyanates include aromatic, aliphatic and cycloaliphatic polyisocyanates and combinations thereof. Representative of these types are diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,4-cyclohexane diisocyanate, the isomers of hexahydrotoluene diisocyanate, 1,5-naphthylene diisocyanate, 1-methylphenyl-2,4-phenyl diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate, and 3,3′-dimethyldiphenylpropane-4,4′-diisocyanate; triisocyanates such as 2,4,6-toluene triisocyanate; and polyisocyanates such as 4,4′-dimethyl-diphenylmethane-2,2′,5,5′-tetraisocyanate and the polymethylene polyphenylisocyanates.

A crude polyisocyanate may also be used in making polyurethanes, such as the crude toluene diisocyanate obtained by the phosgenation of a mixture of toluene diamines. Preferred undistilled or crude toluene polyisocyanates are disclosed in U.S. Pat. No. 3,215,652. Similarly, undistilled polyisocyantates, such as methylene bridged polyphenylpolyisocyanates are useful in the present invention and are obtained by the phosgenation of polyphenylpolymethylenepolyamines obtained by the known process of the condensation of aromatic amines such as aniline with formaldehyde.

Suitable modified diisocyanates or polyisocyanates may be obtained by chemical reaction of diisocyanates and/or polyisocyanates. Modified isocyanates useful in the practice of the present invention include isocyanates containing ester groups, urea groups, biuret groups, allophanate groups, carbodiimide groups, isocyanurate groups, uretdione groups and/or urethane groups.

More preferred polyisocyanates for making rigid polyurethanes are methylene-bridged polyphenyl polyisocyanates and prepolymers of methylene-bridged polyphenyl polyisocyanates, having an average functionality of from about 2.0 to about 3.5, preferably about 2.1 to about 3.1 isocyanate moieties per molecule and an NCO content of from about 28 to about 34% by weight, due to their ability to cross-link the polyurethane. The isocyanate index (ratio of equivalents of isocyanates to equivalents of active hydrogen-containing groups) is advantageously from about 0.9 to about 3.0, preferably about 1.0 to about 2.0 and most preferably from about 1.0 to about 1.5.

Any of the known polyfunctional isocyanate reactive organic compounds may be used to produce foams in accordance with the present invention. The reactive compound can be a single polyol or blend of 2 or more polyols selected so that the polyol or polyol blend has an average of at least three isocyanate-reactive hydrogen atoms per molecule and a hydroxyl (OH) number of from about 200 to about 800, preferably from about 300 to about 650. When a blend of polyols is used, the individual polyols making up the blend can have hydroxyl numbers and functionalities that fall outside the preferred range of the blend.

The molecular weight of the isocyanate-reactive materials are determined from the functionality of the polyol(s) and the equivalent weight determined by the end group analysis method generally used by those skilled in the art and represent a number average molecular weight.

Suitable polyols may be prepared by reacting one or more suitable initiators containing active hydrogens with alkylene oxide. Suitable initiators are those containing at least 2 active hydrogens or combinations of initiators where the mole average of active hydrogens is at leas at 3, preferably from about 3 to about 7, and more preferably from about 3.5 to about 6. Active hydrogens are defined as those hydrogens which are observed in the well-known Zerewitinoff test, see Kohler, Journal of the American Chemical Society, p. 3181, Vol. 49 (1927). Representative of such active hydrogen-containing groups include —OH, —COOH, —SH and —NHR where R is H or alkyl, aryl aromatic group and the like.

Examples of suitable initiators include pentaerythritol, carbohydrate compounds such as lactose, α-methylglucoside, α-hydroxyethyl-glucoside, hexitol, heptitol, sorbitol, dextrose, mannitol, sucrose and the like. Examples of suitable aromatic initiators containing at least four active hydrogens include aromatic amines such as toluene diamine, preferably, ortho-toluene diamine and methane diphenylamine, the reaction product of a phenol with formaldehyde, and the reaction product of a phenol with formaldehyde and a dialkanolamine such as described by U.S. Pat. Nos. 3,297,597; 4,137,265 and 4,383,102 (incorporated herein by reference). Other suitable initiators which may be used in combination with the initiators containing at least four active hydrogens include water, glycols, glycerine, trimethylolpropane, hexane triol, aminoethyl piperazine and the like. These initiators contain less than four active hydrogens and therefore can only be employed in quantities such that the total mole average of active hydrogens per molecule remains at least about 3.0. More preferred initiators for the preparation of the high functionality, high molecular weight polyols comprise sucrose, dextrose, sorbitol, α-methylglucoside, α-hydroxy-ethylglucoside and toluene diamine that may be employed separately or in combination with other initiators such as glycerine, propylene glycol, or water.

The polyols may be prepared by methods well known in the art such as taught by Wurtz, The Encyclopaedia of Chemical Technology, Vol. 7, p. 257-266, Interscience Publishers Inc. (1951) and U.S. Pat. No. 1,922,459. For example polyether polyols can be prepared by reacting, in the presence of an oxyalkylation catalyst, the initiator with an alkylene oxide. A wide variety of oxyalkylation catalysts may be employed, if desired, to promote the reaction between the initiator and the alkylene oxide. Suitable catalysts include those described in U.S. Pat. Nos. 3,393,243 and 4,595,743, incorporated herein by reference. However, it is preferred to use as a catalyst a basic compound such as an alkali metal hydroxide, e.g., sodium or potassium hydroxide, or a tertiary amine such as trimethylamine. The reaction is usually carried out at a temperature of about 60° C. to about 160° C., and is allowed to proceed using such a proportion of alkylene oxide to initiator so as to obtain a polyol having a hydroxyl number ranging from about 200 to about 800, preferably about 300 to about 650, most preferably from about 350 to about 500. The hydroxyl number range of from about 200 to about 800 corresponds to an equivalent weight range of about 280 to about 70.

Polyols of a hydroxyl number greater than 800 may be used as optional ingredients in the process of the present invention.

The alkylene oxides which may be used in the preparation of the polyol include α,β-oxiranes, cyclic ethers having a three member ring, and are unsubstituted or alternatively substituted with inert groups which do not chemically react under the conditions encountered while preparing a polyol. Examples of suitable alkylene oxides include ethylene oxide, propylene oxide, 1,2- or 2,3-butylene oxide, the various isomers of hexane oxide, styrene oxide, epichlorohydrin, epoxychlorohexane, epoxychloropentane and the like. Most preferred, on the basis of performance, availability and cost are ethylene oxide, propylene oxide, butylene oxide and mixtures thereof, with ethylene oxide, propylene oxide, or mixtures thereof being most preferred. When polyols are prepared with combinations of alkylene oxides, the alkylene oxides may be reacted together, as a mixture providing a random distribution of oxyalkylene units within the oxide chain of the polyol or alternatively they may be reacted in a step-wise manner so as to provide a block distribution within the oxyalkylene chain of the polyol.

The amines and polyamines useful as starters in the practice of the present invention may be prepared by any of the known methods. For example, via the nitration of an aromatic hydrocarbon with nitric acid followed by reduction, as in the preparation of toluene diamine (TDA), or via the reaction of ammonia with epoxides to obtain alkanol amines, such as ethanol amine, or via the condensation reaction of aldehydes with aromatic amines such a aniline to produce methylene bridged polyphenylpolyamines (polymeric methylene dianiline, otherwise known as MDA). Suitable optional polyols include polyether polyols, polyester polyols, polyhydroxy-terminated acetal resins, hydroxy-terminated amines and polyamines. Examples of these and other suitable materials are described more fully in U.S. Pat. No. 4,394,491, particularly in columns 3 to 5 thereof. Most preferred for preparing rigid foams are those having from about 2 to about 7 active hydrogens and having a hydroxyl number from about 50 to about 800, preferably from about 100 to about 650. Examples of such polyols include those commercially available under the product names Terate (available from KoSa), Stepanpol (available from Stepan Chemical Corporation) and Multranol (available from Bayer Corporation).

Other components useful in producing the polyurethanes of the present invention include catalysts, surfactants, pigments, colorants, fillers, antioxidants, flame retardants, stabilizers, and the like.

When preparing polyisocyanate-based foams, it is generally advantageous to employ a minor amount of a surfactant to stabilize the foaming reaction mixture until it obtains rigidity. Such surfactants advantageously comprise a liquid or solid organosilicon compound. Other, less preferred surfactants include polyethylene glycol ethers of long chain alcohols, tertiary amine or alkanolamine salts of long chain alkyl acid sulfate esters, alkylsulfonic esters and alkylarylsulfonic acids. Such surfactants are employed in amounts sufficient to stabilize the foaming reaction mixture against collapse and the formation of large and uneven cells. Typically, about 0.2 to about 5.0 parts by weight of the surfactant per 100 parts polyol composition are sufficient for this purpose.

One or more catalysts are advantageously used. Any suitable urethane catalyst may be used including the known tertiary amine compounds and organometallic compounds. Examples of suitable tertiary amine catalysts include triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′, N′-dimethylisopropyl-propylene diamine, N,N-diethyl-3-diethyl aminopropylamine and dimethyl-benzyl amine. Examples of suitable organometallic catalysts include organomercury, organolead, organoferric and organotin catalysts, with organotin catalysts being preferred. Suitable organotin catalysts include tin salts of carboxylic acids such as dibutyltin di-2-ethyl hexanoate and dibutyltin dilaurate. Metal salts such as stannous chloride can also function as catalysts for the urethane reaction. A catalyst for the trimerization of polyisocyanates, such as an alkali metal alkoxide or carboxylate, or certain tertiary amines may also optionally be employed herein. Such catalysts are used in an amount, which measurably increases the rate of reaction of the polyisocyanate. Typical amounts are about 0.01 to about 3 part of trimerization catalyst per 100 parts by weight of polyol. Examples of such catalysts include the potassium salts of carboxylic acids such as potassium octoate, and the tertiary amine N,N′,N″-tris(3-dimethylaminopropyl) hexahydro-s-triazine.

The components described may be employed to produce rigid polyurethane and polyurethane-modified isocyanurate foam. The rigid foams of the present invention may be made in a one-step process by reacting all of the ingredients together at once, or foams can be made by the so-called “quasi prepolymer” method. In the one-shot process where foaming is carried out using machines, the active hydrogen containing compounds, catalyst, surfactants, blowing agents and optional additives may be introduced separately to the mixing head where they are combined with the polyisocyanate to give the polyurethane-forming mixture. The mixture may be poured or injected into a suitable container or molded as required. For use of machines with a limited number of component lines into the mixing head, a premix of all the components except the polyisocyanate can be advantageously employed. This simplifies the metering and mixing of the reacting components at the time the polyurethane-forming mixture is prepared.

Alternatively, the foams may be prepared by the so-called “quasi prepolymer” method. In this method a portion of the polyol component is reacted in the absence of catalysts with the polyisocyanate component in proportion so as to react from about 10 percent to about 30 percent of free isocyanate groups based on the polyisocyanate. To prepare foam, the remaining portion of the polyol is added and the components are allowed to react together in the presence of catalysts and other appropriate additives such as blowing agent, surfactant, etc. Other additives may be added to either the isocyanate prepolymer or remaining polyol or both prior to the mixing of the components, whereby at the end of the reaction a rigid polyurethane foam is provided.

The polyurethane foams of this invention are useful in a wide range of applications. Accordingly, not only can rigid appliance insulating foam be prepared but also spray insulation, rigid insulating board stock, laminates and many other types of rigid foam can easily be prepared according to this invention.

The following Examples are given as being illustrative thereof. All parts and percentages given in these Examples are parts by weight and percentages by weight, unless otherwise indicated.

### EXAMPLES

The following materials were used in the Examples, which follow:

| | |
|---|---|
| POLYOL: | A blend made up of (1) 55% by weight (based on total |
| | weight of POLYOL blend) of an polyether polyol |
| | prepared by alkoxylating a sucrose, propylene glycol |
| | and water starter having a hydroxyl number of about |
| | 470 mg KOH/g and a functionality of about 5.2; |
| | (2) 25% by weight (based on total weight of POLYOL |
| | blend) of an ortho-toluene diamine-initiated polyether |
| | polyol having a hydroxyl number of about 390 mg |
| | KOH/g and a functionality of about 4; and (3) 20% by |
| | weight (based on total weight of POLYOL blend) of |
| | Stepanpol PS-2502A, an aromatic polyester polyol |
| | having an OH number of about 240 mg KOH/g which |
| | is commercially available from Stepan Company. |
| SURFACTANT: | A silicone surfactant that is commercially available |
| | from Air Products and Chemicals Inc. under the |
| | designation DABCO DC-5357. |
| CATALYST A: | (Pentamethyldiethylenetriamine) A tertiary amine |
| | catalyst that is commercially available from Rhein |
| | Chemie Corporation under the name Desmorapid PV. |
| CATALYST B: | A strongly basic, amber-brown liquid having a |
| | characteristic amine odor which is commercially |
| | available from Air Products under the designation |
| | Polycat 41. |
| HCFC-22: | Chlorodifluoromethane, commercially available from |
| | DuPont under the designation Formacel S. |
| HFC-245fa: | 1,1,1,3,3-pentafluoropropane, commercially available |
| | from Honeywell under the designation Enovate 3000. |
| ISO: | A modified polymeric methylenediphenyl diisocyanate |
| | having an NCO group content of about 30.5% which is |
| | available from Bayer Corporation as Mondur 1515. |

### Examples 1 and 2

POLYOL, SURFACTANT, CATALYST A, CATALYST B, WATER and the blowing agents HCFC 22 and HFC 245fa were combined in the amounts indicated in TABLE 1. This mixture was then combined with the amount of ISO indicated in TABLE 1. All foams were prepared using an HK-100 high pressure Hennecke foam machine with an MQ 12-2 mixhead. The liquid output was maintained at a constant 60 lbs/min. and the recycle and pour pressures were held at 1500 psig. The minimum fill density was determined from foam panels poured into a temperature controlled Bosch Panel mold at 120° F. (49° C.) with an internal volume of 79 inches (200 cm) by 8 inches (20 cm) by 2 inches (5 cm). The liquid foam mixture was injected into the mold through the pour hole located near the bottom while the mold was held in a vertical position. The minimum fill density was determined from the minimum weight of foam that was needed to just fill the mold's interior volume. To do this, three panels were poured at about 55, 65, and 75 inches (140, 165, and 190 cm) and linear regression of weight versus height was used to determine the minimum fill weight and calculate the minimum fill density. Panels were then prepared at four higher densities of about 0.10, 0.15, 0.20 and 0.25 lb/ft³ over the minimum fill density. The top half of each panel was cut into ten sections of about 4 inches (10 cm ) each and subjected to −4° F. (−20° C.) for at least 16 hours. The panel with the lowest density which exhibited no significant dimensional change was considered to be freeze stable. Additional panels for foam properties were all prepared at this “freeze stable density”. The properties of the foam are reported in TABLE 1.

TABLE 1

| | EX | |
|---|---|---|
| Mat'l/ | 1* | 2 |
| POLYOL pbw | 66.72 | 71.1 |
| SURFACTANT pbw | 2.42 | 2.47 |
| CATALYST A, pbw | 1.33 | 1.33 |
| CATALYST B pbw | 0.66 | 0.66 |
| WATER pbw | 0.80 | 0.82 |
| HCFC-22 pbw | — | 9.26 |
| HFC-245fa pbw | 28.07 | 14.35 |
| ISO pbw | 93.4 | 97.9 |
| Minimum fill weight lb/ft³ | 1.89 | 2.07 |
| Freeze Stable Density, lb/ft³ | 2.09 | 2.22 |
| Average k-Factor Btu-in/hr · ft² ° F. @ 35° F. | 0.116 | 0.114 |
| Average k-Factor Btu-in./hr · ft² ° F. @ 75° F. | 0.131 | 0.130 |
| Average Core Density (lbs/ft³) | 1.93 | 2.03 |

*Comparative Example

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of rigid foams having good insulation properties comprising reacting
a) an organic isocyanate with
b) an isocyanate reactive compound in the presence of
c) a blowing agent mixture comprising
(1) 1 to 70% by weight of a hydrogen containing chlorofluorocarbon (HCFC) having a boiling point below 0° C., and
(2) from 30 to 99% by weight of a C₂-C₅ polyfluoroalkane, in which the total of (c1) and (c2) is 100% by weight.

2. The process of claim 1, further comprising the presence of a catalyst.

3. The process of claim 1, further comprising the presence a silicon surfactant and optionally, other additives or fillers.

4. The process of claim 1, wherein the HCFC is chlorodifluoromethane (HCFC-22), 1-chloro-1,1-difluoroethane (HCFC-142b) or a mixture thereof.

5. The process of claim 4 wherein the HCFC is chlorodifluoromethane (HCFC-22).

6. The process of claim 1 wherein the C₂-C₅ polyfluoroalkane is 1,1,1,3,3-pentafluoropropane (HFC-245fa), 1,1,1,2,3,3-hexafluoropropane (HFC-236ea), 1,1,1,3,3,3-hexafluropropane (HFC-236fa), 1,1,1,3,3-pentafluorobutane (HFC-365mfc) or 1,1,1,4,4,4-hexafluorobutane (HFC-356mffm).

7. The process of claim 6, wherein the C₂-C₅ polyfluoroalkane is 1,1,1,3,3-polyfluoroalkane (HFC 245fa).

8. The process of claim 1, further comprising the presence of water.

9. The process of claim 8, wherein the water is present in an amount up to 2% by weight, based on the total weight of components b) and c).

10. The process of claim 1 in which the isocyanate a) is a polymethylene polyphenyl polyisocyanate or modified polymethylene polyphenyl polyisocyanate.

11. The process of claim 1 in which the isocyanate reactive compound b) is a polyol or blend of polyols having an OH number of from about 300 to about 650 mg KOH/g.

12. The process of claim 11 in which the isocyanate reactive compound b) contains a polyamine initiated polyether polyol, a sucrose initiated polyether polyol or a mixture there of, wherein compound b) has an average hydroxyl functionality of from about 3 to about 6 and an OH number of from about 350 to about 500 mg KOH/g.

13. A blowing agent composed of a mixture made up of
(1) 1 to 70% by weight of a low boiling hydrogen containing chlorofluorocarbon, and
(2) from 30 to 99% by weight of a C₂-C₅ polyfluoroalkane, in which the total of (1) plus (2) is 100% by weight.

14. The blowing agent of claim 13, wherein the HCFC is chlorodifluoro-methane (HCFC-22), 1-chloro-1,1-difluoroethane (HCFC-142b) or a mixture thereof.

15. The blowing agent of claim 14, wherein the HCFC is chlorodifluoro-methane (HCFC-22).

16. The blowing agent of claim 13, wherein the C₂-C₅ polyfluoro-=alkane is 1,1,1,3,3-pentafluoropropane (HFC-245fa), 1,1,1,2,3,3-hexafluoro-propane (HFC-236ea), 1,1,1,3,3,3-hexafluropropane (HFC-236fa), 1,1,1,3,3-pentafluorobutane (HFC-365mfc) or 1,1,1,4,4,4-hexafluorobutane (HFC-356mffm).

17. The blowing agent of claim 16, wherein the C₂-C₅ polyfluoroalkane is 1,1,1,3,3-polyfluoroalkane (HFC 245fa).

18. A rigid foam prepared by reacting
a) an organic isocyanate with
b) an isocyanate reactive compound in the presence of
c) a blowing agent mixture comprising
(1) 1 to 70% by weight of a hydrogen containing chlorofluorocarbon (HCFC) having a boiling point below 0° C., and
(2) from 30 to 99% by weight of a C₂-C₅ polyfluoroalkane, in which the total of (1) and (2) is 100% by weight.

19. The foam of claim 18, wherein the HCFC is chlorodifluoromethane (HCFC-22), 1-chloro-1,1-difluoroethane (HCFC-142b) or a mixture thereof.

20. The foam of claim 19, wherein the HCFC is chlorodifluoromethane (HCFC-22).

21. The foam of claim 18, wherein the C₂-C₅ polyfluoroalkane is 1,1,1,3,3-pentafluoropropane (HFC-245fa), 1,1,1,2,3,3-hexafluoropropane (HFC-236ea), 1,1,1,3,3,3-hexafluropropane (HFC-236fa), 1,1,1,3,3-pentafluorobutane (HFC-365mfc) or 1,1,1,4,4,4-hexafluorobutane (HFC-356mffm).

22. The foam of claim 21, wherein the C₂-C₅ polyfluoroalkane is 1,1,1,3,3-polyfluoroalkane (HFC 245fa).

23. The foam of claim 18, wherein the isocyanate reactive compound b) is a polyol or blend of polyols having an OH number of from about 300 to about 650 mg KOH/g.

24. The foam of claim 23, wherein the isocyanate reactive compound b) contains a polyamine initiated polyether polyol, a sucrose initiated polyether polyol or a mixture thereof, wherein compound b) has an average hydroxyl functionality of from about 3 to about 6 and an OH number from about 350 to about 500 mg KOH/g.
